(19) United States
(12) Patent Application Publication
(10) Pub. No.: US 2001/0027986 A1
(43) Pub. Date: Oct. 11, 2001

(54) AIR CLEAVE BREAKER PROFILE FOR IMPROVING CLEAVE YIELD

(76) Inventors: MINDAUGAS FERNAND DAUTARTAS, ALBURTIS, PA (US); JOSEPH MICHAEL FREUND, FOGELSVILLE, PA (US); WILLIAM ANDREW GAULT, READING, PA (US); JOHN MICHAEL GEARY, MACUNGIE, PA (US); GEORGE JOHN PRZYBYLEK, DOUGLASVILLE, PA (US); DENNIS MARK ROMERO, BETHLEHEM, PA (US)

Correspondence Address: THOMAS J D'AMICO, DICKSTEIN SHAPIRO MORIN & OSHINSKY LLP, 2101 L STREET N W, WASHINGTON, DC, 200371526

(21) Appl. No.: 09/333,055

(22) Filed: Jun. 15, 1999

(51) Int. Cl. B26F 3/00

(52) U.S. Cl. 225/1; 225/93; 438/460

(57) ABSTRACT

A cleaving apparatus, system and method which inhibit damage to cleave edges of laser bars are described. The cleaving apparatus includes a cleaving device having a first and a second slope meeting at a solitary cleave line. The slopes are angled to provide a solitary cleave point at the cleave line. Preferably, the first slope is between zero and four degrees and the second slope is about twenty degrees above a support structure upon which the cleaving device is mounted. A source of air may optionally provide air directed at the cleave line to assist in cleaving the laser bars.

### FIELD OF THE INVENTION

The present invention relates to an apparatus and method for use in chip processing. More particularly, the present invention relates to an apparatus and method for efficiently cleaving laser bars into semiconductor laser chips.

### BACKGROUND OF THE INVENTION

The process for forming semiconductor laser chips is well known. Semiconductor chips are formed from completed wafers. The wafers are first scribed and broken into laser bars. After a dielectric, semi-reflective coating has been deposited on the cleaved surfaces of the laser bars, the bars are electrically tested. Then the bars are scribed and broken into individual semiconductor laser chips.

A conventional method for cleaving scribed laser bars into semiconductor laser chips involves passing the laser bars over a roller assembly. As shown in FIG. 5, a breaker assembly 100 is depicted having a support structure 102 and a roller 108. The laser bars 50 are placed on a hoop sheet 36 and passed over the roller assembly 108. There are, however, three cleave points, depicted by the arrows A, B, C, at which the laser bars 50 may be cleaved into semiconductor laser chips 52. If, for example, a laser bar 50 becomes cleaved at point B, at point A, the second cleave point, the cleaved edges of the semiconductor laser chips 52 may rub, grind, or detrimentally contact each other. This contacting of the cleaved edges of the semiconductor laser chips 52 may damage the edges, leading to diminished performance of the chips 52. Likewise, the cleaved edges of the chips 52 may grind together at the point C.

As noted above, the described conventional method has deficiencies. Thus, there is a need in the art for an improved methodology to better cleave a laser bar into individual laser chips.

### SUMMARY OF THE INVENTION

The present invention provides a cleaving apparatus that includes a cleaving device and a support structure upon which the cleaving device is mounted. The slopes meet at a cleave line and are angled to provide a solitary cleave point at said cleave line.

The present invention also provides a cleaving system including a cleaving apparatus, a support element movable over the cleaving apparatus, and a drive assembly for moving the support element over the cleaving apparatus. The cleaving apparatus has a cleaving device with a first and a second slope, meeting at a cleave line. The first and second slopes are angled to provide a solitary cleave point at said cleave line.

The present invention also provides a method for cleaving semiconductor work pieces. The method includes locating a support element on a cleaving apparatus and moving the support element over the cleaving apparatus. The cleaving apparatus has a cleaving device mounted on a support structure, which has a first and a second slope meeting at a cleave line and being angled to provide a solitary cleave point at the cleave line. The semiconductor work pieces become cleaved at the cleave line.

The present invention also provides a method for inhibiting damage to edges of cleaved semiconductor chips by providing a cleaving apparatus having a cleaving device which is mounted on a support structure and which has a first and a second slope, the slopes meeting at a cleave line and being angled to provide a solitary cleave point at said cleave line, locating a support element on the cleaving apparatus, wherein at least one laser bar is mounted on the support element, and moving the support element over the first and second slopes to cleave the laser bar at the cleave line. The first and second slopes are angled to inhibit cleave edges of the laser bar from contacting one another.

These and other features and advantages of the invention will be more clearly understood from the following detailed description of the invention which is provided in connection with the accompanying drawings.

### BRIEF DESCRIPTION OF THE DRAWINGS

FIG. 1 is a side view of a breaker assembly constructed in accordance with a preferred embodiment of the present invention.

FIG. 2 is a disassembled perspective view of the hoop assembly of FIG. 1.

FIG. 3 is an assembled perspective view of the hoop assembly of FIG. 1 with laser bars mounted thereon.

FIG. 4 is an enlarged side view of a portion of the breaker assembly of FIG. 1.

FIG. 5 is a side view of a conventional laser bar cleaving apparatus.

### DETAILED DESCRIPTION OF PREFERRED EMBODIMENTS

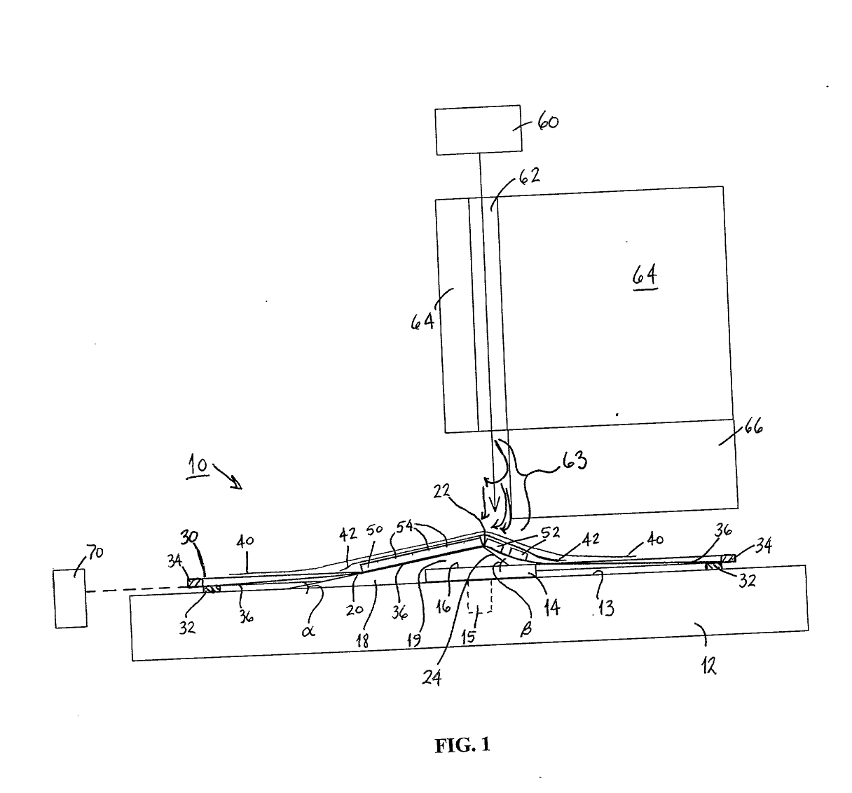

With reference to FIGS. 1-4, there is shown a breaker assembly 10 having a stabilizing support 12, a holding plate 14 and a breaker apparatus 18. The holding plate 14 is mounted on a top surface 13 of the stabilizing support 12 and anchored thereto with an anchor 15. The breaker apparatus 18 has a ledge 19 positioned on a top surface 16 of the holding plate 14.

The breaker apparatus 18 has an approach incline surface 20 which is angled from the top surface 13 of the stabilizing support 12 by an angle α. The angle α must be shallow enough to prevent laser bars 50 from peeling away from an adhesive sheet 36 upon which they are mounted (both to be described in detail below). The preferred range for the angle α is from 0 degrees to 5 degrees. The breaker apparatus 18 further has an exit incline surface 24 which is angled from the top surface 16 of the holding plate 14 by an angle β. Angle β must be sufficiently large to create bending at a cleave point to facilitate cleaving of the laser bars 50, but not too great as to cause grinding of the cleaved surfaces, or the cleave edges, of the semiconductor chips 52 cleaved therefrom. Preferably, the angle β is in the range of from fifteen to twenty-five degrees, and most preferably is about twenty degrees.

Positioned between the approach incline surface 20 and the exit incline surface 24 is a cleave line 22. The angles of the surfaces 20, 24 are such as to make the cleave line 22 the solitary cleaving area in the breaker assembly 10. By providing a single cleaving area to the breaker assembly 10, damage to cleave edges due to rubbing, grinding or other detrimental contact between the cleave edges is inhibited.

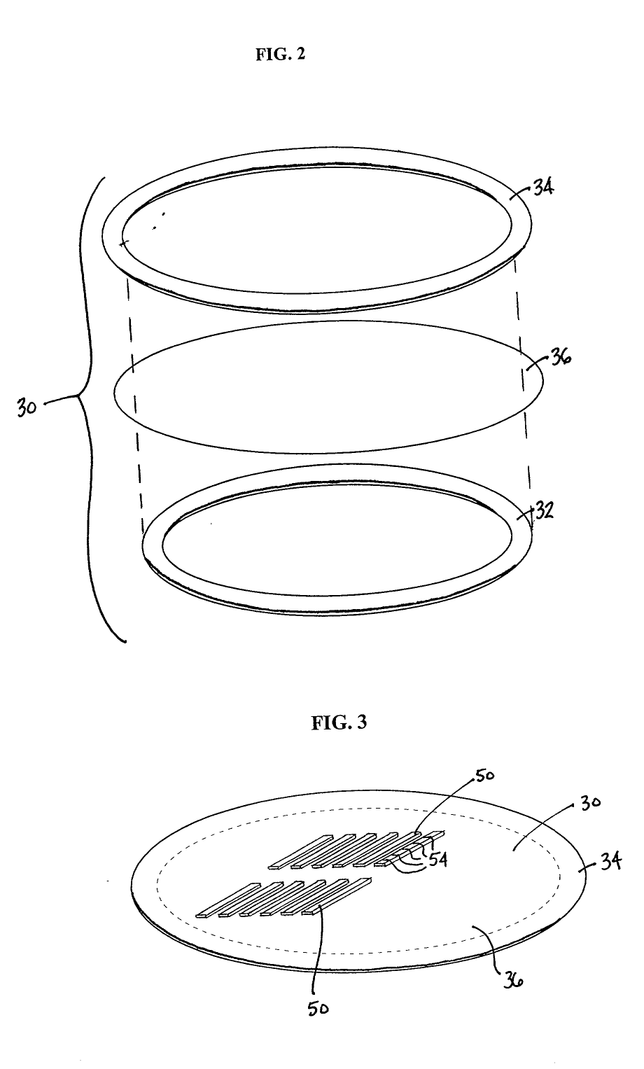

With specific reference to FIGS. 2-3, there is shown a hoop assembly 30. The hoop assembly 30 includes an inner ring 32 and an outer ring 34 which are positioned on either side of an adhesive sheet 36. A plurality of laser bars 50 are placed in rows on the adhesive side of the sheet 36 for cleaving in the breaker assembly 10. The laser bars 50 each have a plurality of scribe lines 54 within a top surface to provide a plurality of weakened areas on the bars 50 at which the bars 50 will be cleaved. Only one of the laser bars 50 is illustrated with scribe lines 54 for clarity of illustration. The adhesive sheet 36 is tautly crimped between the rings 32, 34. The sheet 36 should be sufficiently taut to have no effect on the cleaving of the laser bars 50 but loose enough to allow the sheet 36 to move over the breaker assembly 10.

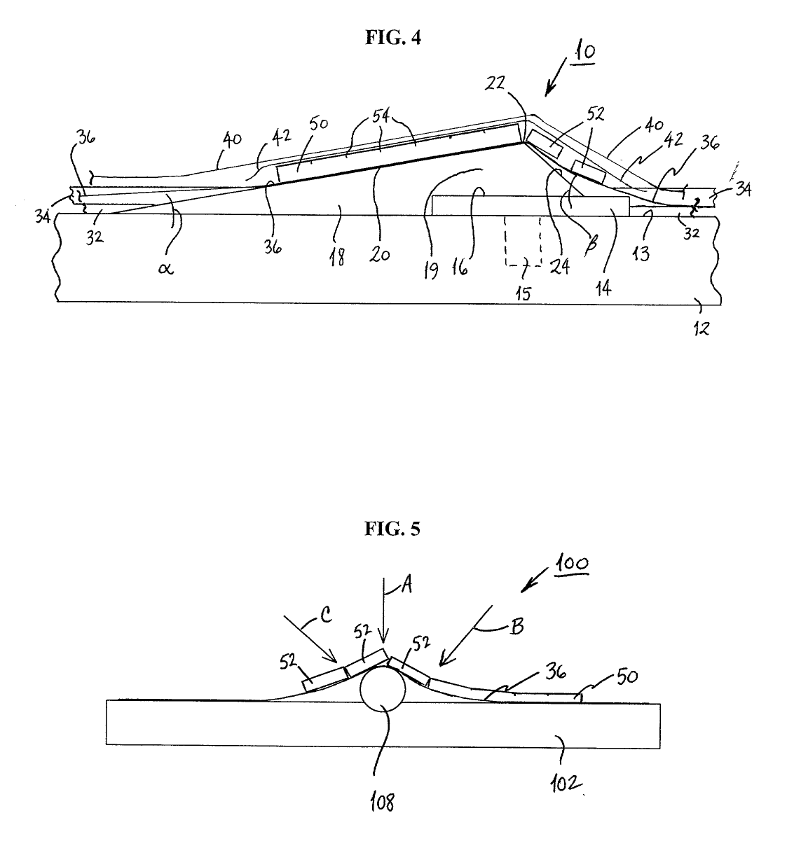

Referring now to FIG. 1, the hoop assembly 30 (the rings 32, 34 of which are shown in cross-section for clarity of illustration) is placed on the stabilizing support 12 such that the sheet 36 runs up the approach incline surface 20 and down the exit incline surface 24. A layer of material 42 is placed above the laser bars 50 on the adhesive sheet 36. Further, a cover sheet 40 is positioned above the layer 42. The layer 42 and the cover sheet 40 are illustrated in FIGS. 1 and 4 apart from the laser bars 50, semiconductor chips 52, and adhesive sheet 36 for clarity of illustration. Typically, the layer 42 would rest upon the laser bars 50, semiconductor chips 52, and adhesive sheet 36 and the cover sheet 40 would rest on the layer 42 and the adhesive sheet 36. The layer 42 may be any suitable material which assists in preventing the laser bars 50, or the discrete semiconductor chips 52 cleaved therefrom, from adhering to the cover sheet 40. Preferably, the layer 42 is a sheet of onion paper.

To assist in the cleaving process, an air source 60 provides high pressure air directed at the cleave line 22. As shown in FIG. 1, the air passes through a pathway 62 in a block assembly 64. The block assembly 64 includes an air foil 66 positioned above the exit incline surface 24 side of the breaker assembly 10. The air foil 66 is provided to deflect the high pressure air away from, and prevent migration of the high pressure air underneath, the cover sheet 40 to thereby prevent disruption of the semiconductor chips 52. The air foil should be formed of a material which will either deflect the air flow or slow it down. Preferably, the air foil 66 is formed of Velcro® or another similar material. As depicted in FIG. 1, the high pressure air travels down through the air pathway 62 and exits near the air foil 66. The combination of the air foil 66 and the cover sheet 40 facilitates the creation of turbulence 63 at a position above the cleave line 22. The force of the high pressure air assists in cleaving discrete semiconductor chips 52 from the laser bars 50. An alternative arrangement for preventing the high pressure air from disrupting the chips 52 may be the provision of air through a passage having a jet at the end (not shown) directed at a slight angle to the cleave line 22 and pointed in the direction of the approach incline surface 20.

Next will be described the method of cleaving the laser bars 50 into the semiconductor chips 52. The hoop assembly 30 with the plurality of laser bars 50 is mounted on the stabilizing support 12. The hoop assembly 30 is moved along the stabilizing support 12 and up the approach incline surface 20 of the breaker apparatus 18 by a drive mechanism 70, shown schematically. The drive mechanism 70 may be any suitable drive assembly, such as, for example, a screw drive motor. Such a drive mechanism 70 may attach to the hoop assembly 30 in a conventional manner, such as, for example, by clamping onto the outer ring 34.

As the first row of laser bars 50 ascend the approach incline 20 and the first scribe lines 54 approach the cleave line 22, the change in direction from the approach incline 20 to the exit incline surface 24 at the cleave line 22 creates sufficient bending of the laser bars 50 at the scribe lines 54 to cleave the laser bars 50 at the scribe lines 54 into discrete semiconductor chips 52. Assisting in this process is the high pressure air coming from the air source 60 through the pathway 62 of the block assembly 64.

Once all of the laser bars 50 have been cleaved into discrete semiconductor chips 52, the drive assembly 70 is reversed, pulling the hoop assembly 30 back over the exit incline surface 24 and down the approach incline surface 20.

Through this arrangement of components, the laser bars 50 may be efficiently cleaved without damage to cleaved surfaces from rubbing, grinding or other detrimental contact between the cleaved surfaces.

While preferred embodiments of the invention have been described and illustrated, the invention is not limited by the foregoing description as many modifications and substitutions can be made without departing from the spirit and scope of the invention. Accordingly, the scope of the present invention is not to be considered as limited by the specifics of the particular structures which have been described and illustrated, but is only limited by the scope of the appended claims.

1. A cleaving apparatus, comprising:
a support structure; and
a cleaving device mounted on said support structure, said cleaving device having a first surface and a downwardly directed second surface meeting at a cleave line, slopes of said first and second surfaces being angled to enable cleaving at said cleave line and to inhibit contact between cleave edges subsequent to cleaving.

2. The apparatus of claim 1, wherein said slopes are angled to provide a solitary cleave point at said cleave line.

3. The apparatus of claim 1, further comprising a holding structure mounted on said support structure, said cleaving device having a ledge positioned upon said holding structure.

4. The apparatus of claim 1, wherein said slope of said first surface is at an angle from said support structure in the range of zero degrees to five degrees.

5. The apparatus of claim 4, wherein said slope of said first surface is at an angle from said support structure of about four degrees.

6. The apparatus of claim 1, wherein said slope of said second surface is at an angle from said support structure in the range of fifteen degrees to twenty-five degrees.

7. The apparatus of claim 6, wherein said slope of said second surface is at an angle from said support structure of about twenty degrees.

8. The apparatus of claim 1, further comprising:
a source of air; and
a conduit for passing air from said source of air downwardly toward said cleave line.

9. The apparatus of claim 8, further comprising an air foil for deflecting said air toward said cleave line.

10. The apparatus of claim 1, wherein said cleaving device is adapted to cleave a plurality of semiconductor work pieces from at least one strip of semiconductor material.

11. The apparatus of claim 10, wherein said cleaving device is adapted to cleave a plurality of semiconductor work pieces from a plurality of strips of semiconductor material.

12. The apparatus of claim 10, wherein said semiconductor material comprises laser bars.

13. The apparatus of claim 12, wherein said laser bars each have a plurality of scribe lines for facilitating cleaving of said laser bars into semiconductor chips.

14. The apparatus of claim 13, further comprising a hoop assembly having an inner and an outer ring sandwiching an adhesive sheet, said laser bars being mounted on an adhesive side of said sheet.

15. The apparatus of claim 14, further comprising a protective covering over said hoop assembly.

16. The apparatus of claim 15, further comprising an automatic feed assembly connected to said hoop assembly for moving said laser bars over said cleave line.

17. A cleaving apparatus, comprising:
a support structure; and
a cleaving device mounted on said support structure, said cleaving device having a first surface and a downwardly directed second surface meeting at a cleave line, slopes of said first and second surfaces being angled to provide a solitary cleave point at said cleave line, to enable cleaving at said cleave line, and to inhibit contact between cleave edges subsequent to cleaving, wherein said slope of said first surface is at an angle from said support structure in the range of zero degrees to five degrees and said slope of said second surface is at an angle from said support structure in the range of fifteen degrees to twenty-five degrees.

18. The apparatus of claim 17, wherein said first slope is angled above said support structure at an angle of about four degrees.

19. The apparatus of claim 17, further comprising a holding structure mounted on said support structure, said cleaving device having a ledge positioned upon said holding structure.

20. The apparatus of claim 17, wherein said slope of said second surface is at an angle from said support structure of about twenty degrees.

21. The apparatus of claim 17, further comprising:
a source of air; and
a conduit for passing air from said source of air downwardly toward said cleave line.

22. The apparatus of claim 21, further comprising an air foil for deflecting said air toward said cleave line.

23. The apparatus of claim 17, wherein said cleaving device is adapted to cleave a plurality of semiconductor work pieces from at least one strip of semiconductor material.

24. The apparatus of claim 23, wherein said cleaving device is adapted to cleave a plurality of semiconductor work pieces from a plurality of strips of semiconductor material.

25. The apparatus of claim 24, wherein said semiconductor material comprises laser bars.

26. The apparatus of claim 25, wherein said laser bars each have a plurality of scribe lines for facilitating cleaving of said laser bars into semiconductor chips.

27. The apparatus of claim 26, further comprising a protective covering over said laser bars.

28. The apparatus of claim 27, further comprising a hoop assembly having an inner and an outer ring sandwiching an adhesive sheet, said laser bars being mounted on an adhesive side of said sheet.

29. The apparatus of claim 28, further comprising an automatic feed assembly connected to said hoop assembly for moving said laser bars over said cleave line.

30. A cleaving system, comprising:
a cleaving apparatus, comprising:
a support structure upon which said cleaving device is mounted; and
a cleaving device mounted on said support structure, said cleaving device having a first surface and a downwardly directed second surface meeting at a cleave line, slopes of said first and second surfaces being angled to enable cleaving at said cleave line and to inhibit contact between cleave edges subsequent to cleaving;
a support device for supporting an element from which individual objects are to be cleaved, said support device being movable over said cleaving apparatus; and
a drive assembly for moving said support device over said cleaving apparatus, whereby an element supported on said support device can be cleaved into individual objects by said cleaving apparatus.

31. The system of claim 30, wherein said first and second slopes are angled to provide a solitary cleave point at said cleave line.

32. The system of claim 30, wherein said cleaving apparatus further comprises a holding structure mounted on said support structure, said cleaving device having a ledge positioned upon said holding structure.

33. The system of claim 30, wherein said slope of said first surface is at an angle from said support structure in the range of zero degrees to five degrees.

34. The system of claim 33, wherein said slope of said first surface is at an angle from said support structure of about four degrees.

35. The system of claim 30, wherein said slope of said second surface is at an angle from said support structure in the range of fifteen degrees to twenty-five degrees.

36. The system of claim 35, wherein said slope of said second surface is at an angle from said support structure of about twenty degrees.

37. The system of claim 30, wherein said cleaving apparatus further comprises:
a source of air; and
a conduit for passing air from said source of air downwardly toward said cleave line.

38. The system of claim 37, further comprising an air foil for deflecting said air toward said cleave line.

39. The system of claim 30, wherein said cleaving device is adapted to cleave a plurality of semiconductor work pieces from at least one strip of semiconductor material.

40. The system of claim 39, wherein said cleaving device is adapted to cleave a plurality of semiconductor work pieces from a plurality of strips of semiconductor material.

41. The system of claim 40, wherein said semiconductor material comprises laser bars.

42. The system of claim 41, wherein said laser bars each have a plurality of scribe lines for facilitating cleaving of said laser bars into semiconductor chips.

43. The system of claim 42, further comprising a protective covering over said laser bars.

44. The system of claim 43, wherein said protective covering comprises a cover sheet and a layer of material placed over said laser bars.

45. The system of claim 44, wherein said layer of material is onion paper.

46. The system of claim 45, wherein said support device comprises a hoop assembly having an inner and an outer ring sandwiching an adhesive sheet, said laser bars being mounted on an adhesive side of said sheet.

47. The system of claim 46, further comprising an automatic feed assembly connected to said hoop assembly for moving said laser bars over said cleave line.

48. The system of claim 47, wherein said automatic feed assembly comprises a screw drive motor.

49. A cleaving system, comprising:
a cleaving apparatus, comprising:
a support structure upon which said cleaving device is mounted; and
a cleaving device mounted on said support structure, said cleaving device having a first surface and a downwardly directed second surface meeting at a cleave line, slopes of said first and second surfaces being angled to provide a solitary cleave point at said cleave line, to enable cleaving at said cleave line, and to inhibit contact between cleave edges subsequent to cleaving, said slope of said first surface is at an angle from said support structure in the range of zero degrees to five degrees and wherein said slope of said second surface is at an angle from said support structure in the range of fifteen degrees to twenty-five degrees;
a support device for supporting an element to be cleaved into individual wafers, said support device being movable over said cleaving apparatus; and
a drive assembly for moving said support device over said cleaving apparatus, whereby an element supported by said support device is cleaved by said cleaving apparatus.

50. The system of claim 49, wherein said slope of said first surface is at an angle from said support structure of about four degrees.

51. The system of claim 49, wherein said cleaving apparatus further comprises a holding structure mounted on said support structure, said cleaving device having a ledge positioned upon said holding structure.

52. The system of claim 49, wherein said slope of said second surface is at an angle from said support structure of about twenty degrees.

53. The system of claim 49, wherein said cleaving apparatus further comprises:
a source of air; and
a conduit for passing air from said source of air downwardly toward said cleave line.

54. The system of claim 53, further comprising an air foil for deflecting said air toward said cleave line.

55. The system of claim 49, wherein said cleaving device is adapted to cleave a plurality of semiconductor work pieces from at least one strip of semiconductor material.

56. The system of claim 55, wherein said cleaving device is adapted to cleave a plurality of semiconductor work pieces from a plurality of strips of semiconductor material.

57. A method for cleaving, comprising the steps of:
moving at least one element to be cleaved over a cleaving apparatus, said cleaving apparatus having a first surface and a downwardly directed second surface meeting at a cleave line, slopes of said first and second surfaces being angled to provide a solitary cleave point at said cleave line such that individual items cleaved by said cleaving apparatus do not contact one another subsequent to cleaving.

58. The method of claim 57, wherein said slope of said first surface is at an angle from a horizontal plane in the range of zero degrees to five degrees.

59. The method of claim 58, wherein said slope of said first surface is at an angle from said horizontal plane of about four degrees.

60. The method of claim 57, wherein said slope of said second surface is at an angle from a horizontal plane in the range of fifteen degrees to twenty-five degrees.

61. The method of claim 60, wherein said slope of said second surface is at an angle from said horizontal plane of about twenty degrees.

62. The method of claim 57, further comprising the steps of:
providing a source of air; and
passing air from said source of air toward the semiconductor work pieces to assist in cleaving said individual items from said element.

63. The method of claim 62, wherein said air is directed at said cleave line.

64. The method of claim 63, further comprising deflecting air toward said cleave line.

65. The method of claim 57, wherein said at least one element is a semiconductor work piece.

66. The method of claim 65, wherein said cleaving apparatus cleaves a plurality of semiconductor work pieces.

67. The method of claim 66, wherein said semiconductor work pieces are laser bars.

68. A method for reducing damage semiconductor chips during cleaving, the method comprising the steps of:
locating a support device on a cleaving apparatus, wherein at least one element is mounted on said support device; and
moving said support device and said element to be cleaved over said cleaving apparatus, said cleaving apparatus having a first surface and a downwardly directed second surface meeting at a cleave line, slopes of said first and second surfaces being angled to provide a solitary cleave point at said cleave line such that individual items cleaved by said cleaving apparatus do not detrimentally contact one another subsequent to cleaving.

69. The method of claim 68, wherein said slope of said first surface is at an angle from a horizontal plane in the range of zero degrees to five degrees.

70. The method of claim 69, wherein said slope of said first surface is at an angle from said horizontal plane of about four degrees.

71. The method of claim 68, wherein said slope of said second surface is at an angle from a horizontal plane in the range of fifteen degrees to twenty-five degrees.

72. The method of claim 68, further comprising:
passing air from a source of air to said cleaving device; and
directing said air toward the laser bar at the cleave line to assist in cleaving the element.

73. The method of claim 68, wherein said at least one element is a semiconductor work piece.

74. The method of claim 73, wherein said cleaving apparatus cleaves a plurality of semiconductor work pieces.
